(19) United States
(12) Patent Application Publication
(10) Pub. No.: US 2005/0275380 A1
(43) Pub. Date: Dec. 15, 2005

(54) System and method for adding electrolyte to an energy storage cell

(75) Inventors: Thomas J. McCall, Ft. White, FL (US); Jon K. West, Gainesville, FL (US); Thomas E. Audit, Alachua, FL (US)

Correspondence Address: MORRISON & FOERSTER LLP, 1650 TYSONS BOULEVARD, SUITE 300, MCLEAN, VA, 22102, US

(73) Assignee: WAVECREST LABORATORIES, Dulles, VA (US)

(21) Appl. No.: 10/857,447

(22) Filed: Jun. 1, 2004

(51) Int. Cl. H01M 2/00; C25B 15/00

(52) U.S. Cl. 320/137; 205/687

(57) ABSTRACT

Disclosed is a system and method for increasing the rate at which an electrolyte permeates the micropores of an energy storage cell. In a preferred embodiment, an energy storage cell is filled with a quantity of an electrolyte which is then exposed to an electric field. The electrolyte is electrophoretically driven into the micropores of the energy cell at a rate that is greater than without the use of electrophoresis.

### FIELD OF THE INVENTION

The present invention, in a preferred embodiment, relates to a system and method for adding electrolyte solution to an energy storage cell having a pair of electrodes and one or more separators. In a preferred embodiment, the present invention may be characterized as a system and method for increasing battery production capacity, improving electrolyte fill accuracy, and reducing the time for adding an electrolyte solution to the storage cell by creating a potential differential between the electrodes while adding the electrolyte solution.

### BACKGROUND OF THE RELATED ARTS

In the manufacture of electrochemical power supplies, there is a great deal of interest in developing better and more efficient methods for storing energy in electrochemical cells having high energy density and high power density. Increasing power per unit volume and increasing discharge characteristics depends on the ability to fabricate thinner electrodes and thinner separators. Increasing production capacity requires reducing “bottlenecks” during the production of such batteries. One area that reduces battery production capacity is the process of filling an electrochemical energy storage cell with an electrolyte solution, due to the time it takes for the solution to be absorbed by the electrodes and separator and the limited amount of head-space available in the cell container to dispose the electrolyte solution while it is being absorbed.

An electrochemical cell uses its cathode and anode electrodes to generate an electric current. The electrodes are typically separated from one another by porous separator elements. During the manufacture of the electrochemical cell, the anode, the separator and the cathode are laminated together to form a laminated cell structure and/or tightly wound to form a coiled electrochemical cell structure. This electrochemical cell structure is then filled with an electrolyte solution to maintain the flow of ionic conduction between the electrodes. The amount and the distribution of electrolyte within the cell volume is important for the cell's overall performance.

In the prior art, there are several methods for filling electrochemical cells with electrolyte. In one exemplary prior art process, the laminated cell structure is rolled on a mandril to yield a cylindrical spiral wound roll, which is referred to as “jelly roll”. The roll is then placed into a container having an electrolyte fill port. Once the container is sealed, electrolyte is injected into the container through the fill port and subsequently the fill port is sealed. In another prior art process, the laminated cell structure is maintained in a flat prismatic configuration and soaked in an electrolyte solution until the porous laminated structure is flooded. Subsequently, the cell is placed into a cell container and the container is sealed.

However, as state-of-the-art electrodes and separators become thinner to increase the power density of the cell, such established prior art processes for filling cells become less efficient. The state of the art thin electrochemical cells include micro-porous cell components (i.e., separators and electrodes). These components contain smaller pores which inhibit the transport of liquid electrolyte throughout the cell. For example, the transport of the electrolyte in the porous cell structure may be significantly reduced or inhibited if the surface tension of the electrolyte is not significantly lower than the surface energy of the liquid inside the pores in the media. Additionally, as liquid electrolyte enters the pore structure of the electrodes and separator, gas (typically air) in the pore structure must be displaced with the electrolyte. However, thin separators also restrict the egress of gas from the cell. These conditions greatly increase the amount of time required to fill the cell with electrolyte, and the difficulty in assuring a uniform filling of the separator material.

Further, due to the time required to add electrolyte to energy storage cells according to prior art methods, when the electrolyte and negative plate of the cell are at approximately the same potential, the electrolyte may wick upwardly along the side of the cell container and enter the closure between the container and the cover. The wicking action, therefore degrades the integrity of the closure of the cell.

In order to overcome these problems, several modifications in the prior art processes have been suggested. In one technique, the thin laminated structure is placed into a container having an adequate headspace. The head space accommodates the overflow of electrolyte above the cell until the electrolyte is drawn into the separator and porous electrode structures. However, due to the slow displacement of gas in the porous structure, this technique is time consuming and increases manufacturing costs.

Alternatively, to decrease the amount of time required for the filling process, surfactants can be added to the electrolyte to reduce the surface tension of the electrolyte and improve the wetting of the porous cell components in the cell. In addition, co-solvents may be added to the electrolyte to reduce the viscosity of the liquid and thereby increase the flow of electrolyte into the porous components of the cell. However, preparing electrolyte solutions with such chemistry adds materials to the electrolyte that do not contribute to the electrochemical performance of the cell, but do add to the manufacturing cost. In an alternative approach, a cell may be filled under vacuum to eliminate the slow displacement of gas from the pore structure when the electrolyte is added.

In another prior art method, a fill port is included in each perimeter seal of each cell in a multi-cell battery. The aligned fill ports in a bipolar stack are submerged in electrolyte and a vacuum is applied to extract the gas from the cell components. As the stack is brought back to atmospheric pressure, the electrolyte is drawn into the individual cells. The excess electrolyte is then cleaned from the outside of the cell stack, and each fill port is sealed.

In yet another prior art method, each side of the bipolar current collector is fitted with an elastic gasket to form a shallow cup which contains the anode and cathode materials on either side of the current collector. In this method, the anode or the cathode or both electrodes may be prepared as slurries comprising an active electrode material and an electrolyte. Carbon powder may also be added to this slurry to enhance the electronic conductivity of the electrode. These electrolyte soaked bipolar electrodes are stacked between porous separators under pressure. The elastic gaskets hold the separators in place and seal the perimeters of the cells. Alternatively, the gaskets are made of thermal plastics which are thermally sealed after the bipolar electrodes are stacked in series with the separators. In these cases fill ports are not required.

For all of these methods, attention must be directed to the distribution of the electrolyte in the cell during closure of the cell and closure of the fill ports. Typically, cells and fill ports are closed or sealed with adhesives, thermal plastics, elastomers (crimp seals), or by welding when metal containers (cans) are used. In order to provide a leakage free seal, all joining surfaces must be free of electrolyte.

It can be appreciated that energy storage cell filling has been in use for years, commonly with potassium hydroxide (KOH). Typically, KOH fill machines use a drip-fill mechanism. Such devices work by taking a positive displacement pump, which measures a precise amount of liquid, which then pumps the electrolyte into a vessel which then allows the electrolyte to drip into the cell.

A second common method of KOH filling is Vacuum Filling. The cell is placed under a vacuum and the KOH is injected or introduced into the cell under the vacuum. The KOH is soaked up into cell. Another method that is conventionally used for KOH fill is centrifugal filling, wherein a cell is placed in a holder on a machine that rotates at some RPM to create a centrifigal force and the KOH is introduced into the cell at this time.

While these devices may be acceptable for the particular purpose which they address, they are not as suitable for microporous battery plates. The main problem with conventional KOH filling is that mechanical forces cannot overcome the hydraulic forces that exist inside micropores. Vacuum fill, centrifugal fill, and drip fill all depend on external mechanical forces to push the electrolyte into the pores of the plate. With a vacuum pulled on the cell, the KOH is injected or introduced into the cell vacuum and is soaked up into cell incompletely because the osmotic forces are several times greater than that of a full vacuum. This is likewise true for centrifugal filling and drip filling

For these reasons, it is desirable for there to be an electrolyte filling system and method that substantially departs from the conventional concepts and designs of the prior art, and in so doing provides an apparatus primarily developed for the purpose of overcoming the osmotic forces of microporous battery plate by electrophoresis. Moreover, there is a need in the electrochemical cell manufacturing industry for processes for filling thin electrochemical cells with electrolyte in a manner that greatly increases the speed at which the electrolyte is absorbed into the porous cell components of the cell, preferable without the addition of material to the electrolyte solution that does not contribute to the overall performance of the energy storage device.

### SUMMARY OF THE INVENTION

Disclosed is a preferred exemplary system and method for filling energy storage cells. The preferred method may include adding an electrolyte solution to an energy storage cell and then exposing the storage cell to an electric field. In one embodiment, a positive electrode is placed in contact with a collector on a coiled energy storage device. A negative, or ground, electrode may be placed in contact with a container in which the coiled energy storage device is disposed. A measured quantity of an electrolyte may be added to the energy storage device. A current of 2-10 amps may be applied between the electrodes, electrophoretically forcing the electrolyte into the pores and micropores of the energy storage device. In other embodiments in accordance with the present invention, the disclosed order of steps may be carried out in different sequences, or carried out concurrently, depending on the design of the filling apparatus, type of cell being produced, etc.

In another embodiment of the invention, the filling process is iterative. A small amount of electrolyte may be added to the cell container, usually depending on the amount of available head space in the container. The electrolyte then enters the porous substrate and electrolyte layers thereon with a current applied to accelerate the penetration of the pores. As head space becomes available in the container, additional electrolyte is added to the container, and the process repeats. The process is complete when the desired amount of electrolyte has been added to the container and has penetrated the pores of the electrodes.

Also disclosed is a preferred exemplary machine for filling energy storage devices with electrolyte solution. Such a machine may include a track for manipulating one or more energy storage devices and means for applying a voltage to the electrodes. Preferably a constant current source is used, as the voltage demands of the system will change according to the number of cells being filled at a given time. The filling machine may include track may include a positive track and a negative, or ground, track. The energy storage device is disposed on the track and an optional spring-loaded mechanism may contact a collector on the energy storage device while the ground track contacts the container holding the energy storage device. A positive displacement fill-pump may then meter a desired quantity of electrolyte into the container. A current is then applied across the positive and ground tracks, electrifying the container, and electrophorectically forcing the electrolyte into the pores and micropores of the energy storage device.

The disclosed system and method also provides the ability to minimize wicking during the electrolyte fill process, substantially avoiding the presence of electrolyte between the cell container and cover. The disclosed system and method, therefore, provides for improved integrity of the closure of the cell and reduces the soak-time for a closed cell prior to the first formation cycle.

### BRIEF DESCRIPTION OF THE DRAWING FIGURES

FIG. 1 illustrates an embodiment of a device for filling electrochemical energy storage cells with an electrolyte solution using electrophoresis.

FIG. 2 illustrates an embodiment of a track mechanism having positive and negative electrodes, configured to receive an energy storage device.

FIG. 3 illustrates an exemplary energy storage device having electrodes connected thereto for applying a current to the energy storage device and thereby allowing electrophoresis to occur within the cell during the filling process.

FIG. 4 illustrates a top plan view of an exemplary filling machine in accordance with the present invention.

FIG. 5 illustrates a side view of an exemplary filling machine showing multiple storage cells on a track mechanism having connections to a positive and negative electrode during the filling process.

FIG. 6 illustrates an exemplary mechanism for connecting an energy storage cell to a filling machine having positive and negative electrodes and a spring loaded electrode is provided that is compressed by the positive track to contact the cell and to electrify the cell.

FIG. 7 illustrates an alternative embodiment of an energy storage device filling machine in side view.

FIG. 8 illustrates another view of an exemplary filling machine for energy storage cells.

### DETAILED DESCRIPTION OF THE INVENTION

The present invention, in a preferred embodiment, relates to an electrical energy storage device and, more specifically, to rechargeable storage cells. By way of example and illustration, the present specification describes D-Cell batteries. It is noted, however, each of the principles and discoveries mentioned herein apply with equal weight to cells having a coiled energy storage device, such as AA, AAA, C, for example, and other cells which do not use cylindrically wound coils like prismatic batteries, oval cells, etc.

Particularly, the present specification relates to a novel method and apparatus for saturating the porous components of an electrochemical cell with an electrolyte solution. This method and apparatus permits the porous components of the electrochemical storage cell to be saturated more quickly and with improved quality than is permitted by prior art methods, such as drip-filling, vacuum filling, or centrifugal filling.

Exemplary energy storage devices for use in accordance with the presently disclosed system and method are described in U.S. Pat. No. 6,265,098, U.S. Pat. No. 5,667,907, U.S. Pat. No. 5,439,488, and U.S. Pat. No. 5,370,711, each of which is hereby incorporated by reference in its entirety.

A typical electrochemical storage cell relies on the transfer of ions between electrodes to create a voltage differential. The voltage differential, in turn, enables the production of current. The electrodes are generally in the form of plates made from metallic, galvanic couples which are coated with a paste of an electrolytic material, such as NiMH or Ni(OH)₂, depending on whether the electrode is to be used as an anode or a cathode. Between the electrodes, there is usually a separator, or similar porous material that allows an electrolyte solution to flow between the plates, permitting ion exchange, without the plates coming into contact with each other and shorting out the cell. Typical separators may be made from woven glass, polypropylene, or other polymers and synthetic materials. According to the present system and method, however, polypropylene mat separators are preferred.

An electrolyte, such as potassium hydroxide (“KOH”), is then used to wet the electrodes and separator, providing a medium for electron flow between the electrodes of the energy storage device. The wetting of the electrodes affects the performance of the energy storage device, since improper permeation of the electrolytic pastes results in reduced performance. Due to the very small pores that exist in present-day thin-film electrodes and separators, drip-filling and other prior art methods are slow, thereby creating a bottleneck in the production of energy storage devices while the electrolyte saturates the porous components of the storage cell.

Prior art methods typically require in excess of 20-200 minutes, depending on the cell size, design, and porosity, for the electrolyte to permeate the microporous components of the cell. It has been found, however, that by exposing the microporous components of the storage cell to an electric field while adding the electrolyte solution may decrease the time it takes for the electrolyte to permeate the pores.

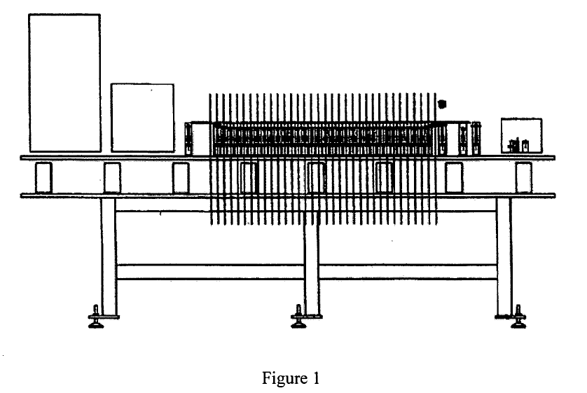

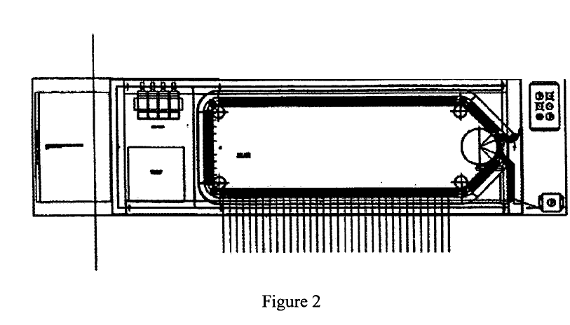

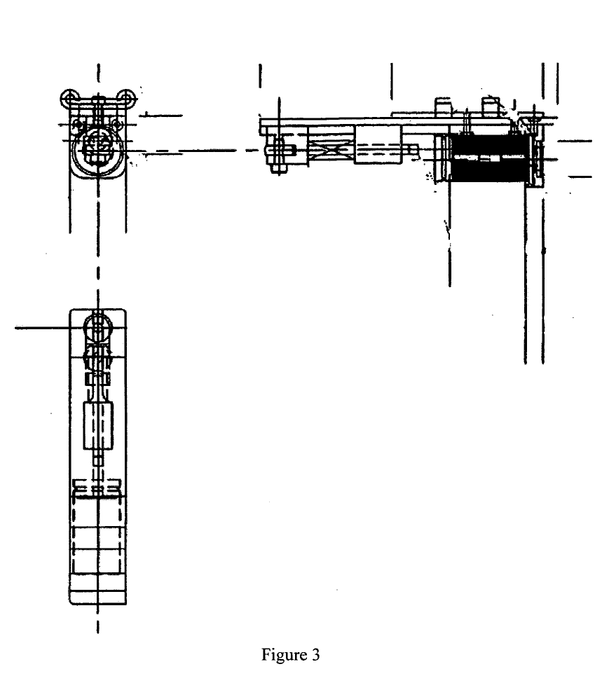

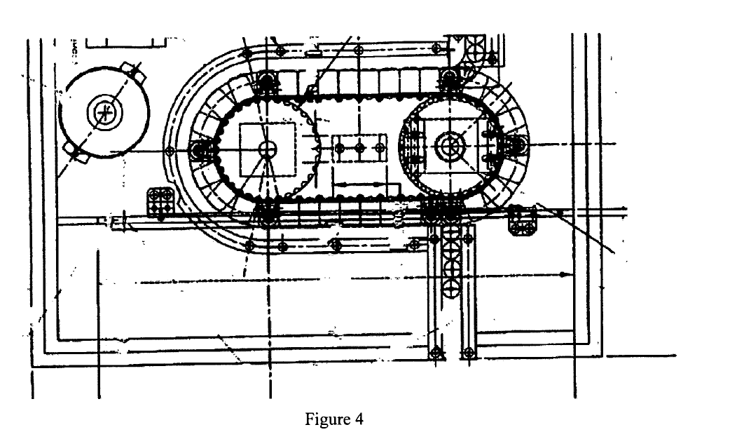

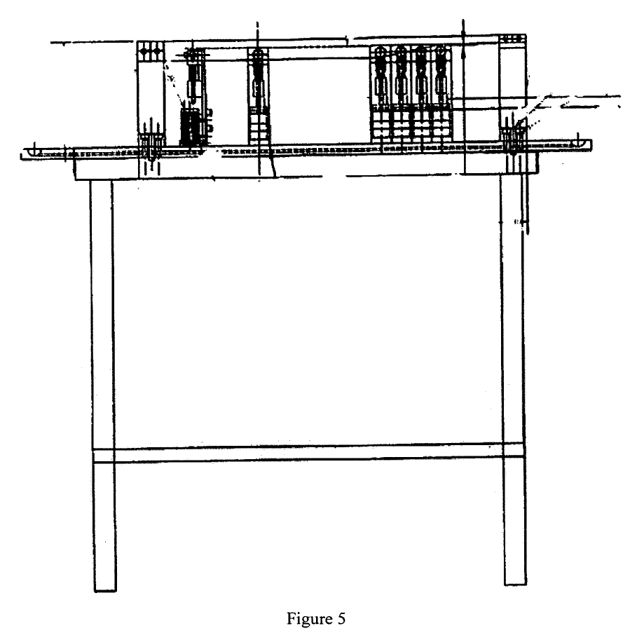

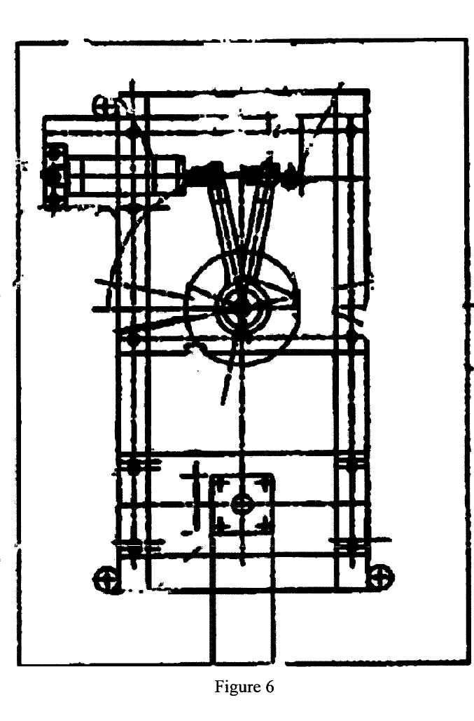

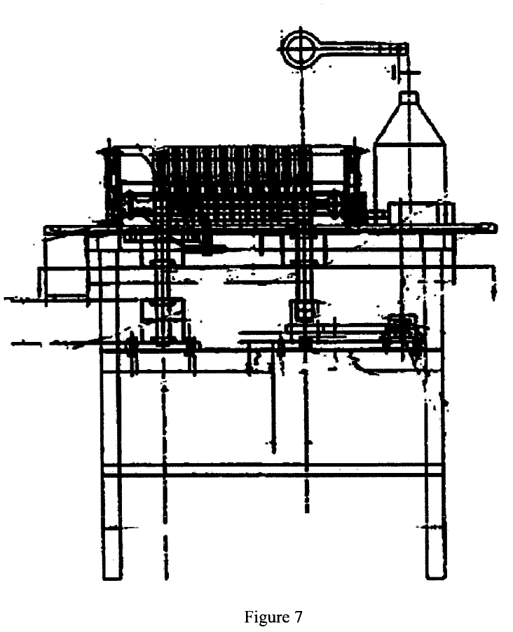

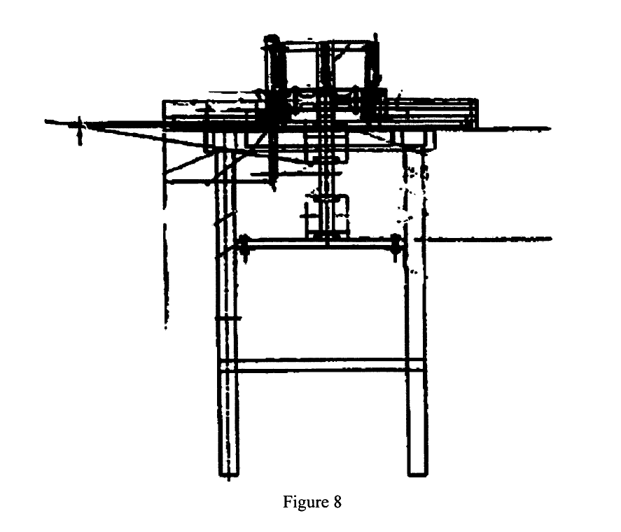

A filling machine may be fabricated which permits the electrophoretic filling of energy storage cells. In preferred embodiments of such a machine, as shown in FIGS. 1-2, 4-5, and 7-8, there may be a track with an indexing mechanism for locating and managing multiple cells, by including multiple cell-holders. The track may include a positive track, or electrode, and a negative track, or electrode, as shown in FIG. 4, which receive the energy storage cell and provide for electrical contact between the positive and negative plates of the cell. The filling machine includes a mechanism for applying a current through the positive track to each cell in each cell holder, as shown in FIG. 3, or to one or more cells at any given time. Preferably, a spring loaded electrode is provided that is compressed by the positive track to contact the cell and to electrify the cell, electrophoretically driving the electrolyte into the micropores of the plates of the cell. Such a mechanism is shown in FIG. 6.

In another embodiment of a filling process, fill rate and wetting are improved, as follows. A canned roll is prepared with the positive electrode (collector) welded to the top of the roll. A measured amount of electrolyte, KOH for example, is prepared. A positive displacement electrolyte pump then places the measured amount of electrolyte into the cell. A positive electrode is then positioned onto the collector and a negative electrode contacts the can. About 2-10 amps of current is then applied, forcing the electrolyte electrophorectically into the pores and micropores of the energy cell, filling the coil almost immediately. This method may result in filling a storage cell in about 10-100 seconds. This compares to prior art filling times of 10-30 minutes, which may result in over 100 times improvement in productivity, depending upon the cell design, size, and porosity of the components. As well, the prior art does not provide the ability to fill tightly wound D-cell type batteries with polypropylene mat separators. Using the systems and methods described herein, however, such a cell may be filled in approximately 4 minutes. Using prior art method, D-cell type batteries having nylon separators may be filled in no less than about 15 minutes. When using the present system and method such a cell may be filled in less than 15 minutes. Moreover, due to the increase in fill-rate, filling machines may be made smaller, since the residence time of a container on the machine can be reduced. This may permit a machine that is 100×50 feet to be reduced to 3×8, depending on the cell size, design, and porosity, when using the electrophoretic process.

### EXAMPLE 1

Electrophoretically Filled Coiled Cell

An anode, cathode, and polypropylene mat separator are rolled on a mandril to yield a cylindrical spiral wound roll, which is referred to as “jelly roll” for use in a D-cell type battery of approximately 80 cm³. The roll is then placed into a container having an electrolyte fill port and loaded onto a filling machine as shown in FIG. 1. The filling machine includes a positive displacement pump for metering a desired amount of electrolyte into the cell container, a grounding track (or electrode), and a positive track (or electrode). In the filling machine of this example, the positive track is spring loaded to receive and hold the cell container.

The container is sealed and exposed to a current that is applied to the cell via the positive and negative tracks of the filling machine. A potassium hydroxide electrolyte is metered by the positive displacement pump and injected into the container through a fill port. The desired amount of electrolyte is added to the container and permeates the porous components of the cell in about 4 minutes. The fill port is then sealed.

### EXAMPLE 2

Non-Electrophoretically Filled Coiled Cell

An anode, cathode, and polypropylene mat separator are rolled on a mandril to yield a cylindrical spiral wound roll, using the same materials and for the same purpose as in Example 1. The roll is then placed into a container having an electrolyte fill port. The container is sealed, but is not exposed to an electric field. A potassium hydroxide electrolyte is injected into the container through a fill port. The desired amount of electrolyte is added to the container and permeates the porous components of the cell in about 1 hour. The fill port is then sealed.

### EXAMPLE 3

Non-Electrophoretic Filling of a Prismatic Energy Cell

In another example, a laminated cell structure for use in a lithium-ion prismatic cell configuration is soaked in an electrolyte solution until the porous laminated structure is flooded. Subsequently, the cell is placed into a cell container and the container is sealed. The time taken for the electrolyte to permeate the porous components of the cell is measured at about 20 minutes.

### EXAMPLE 4

Electrophoretic Filling of a Prismatic Energy Cell

In another example, the cell structure of Example 3 is soaked in an electrolyte solution until the porous laminated structure is flooded and exposed to an electric field. Subsequently, the cell is placed into a cell container and the container is sealed. The time taken for the electrolyte to permeate the porous components of the cell is measured at about 60 seconds.

An energy storage device in accordance with the present invention may be used for storing and supplying energy in a variety of different environments and for a variety of different purposes. For example, an energy storage device in accordance with the present invention may be used for storing and supplying energy in transportation vehicles, including for example ground transportation vehicles, air transportation vehicles, water surface transportation vehicles, underwater transportation vehicles, and other transportation vehicles. An energy storage device in accordance with the present invention may be used for storing and supplying energy in communication and entertainment devices, including for example telephones, radios, televisions and other communication and entertainment devices. An energy storage device in accordance with the present invention may be used for storing and supplying energy in home appliances, including for example flashlights, emergency power supplies, and other home appliances. The examples described in this paragraph are merely representative, not definitive.

1. A method comprising:
providing an energy storage device comprising at least one porous element,
introducing electrolyte to the energy storage device, and
applying electrical potential sufficient to cause the electrolyte to permeate the at least one porous element.

2. A method comprising:
providing an energy storage device comprising at least one electrode,
establishing an electrical potential relative to the at least one electrode, and
introducing electrolyte to the energy storage device.

3. A method comprising:
providing an energy storage device comprising at least one porous element, and
electrophoretically permeating the at least one porous element with electrolyte.

4. A method comprising:
providing an energy storage device having a volume not less than 80 cm³ and comprising at least one electrode,
establishing a electrical potential relative to the at least one electrode, and
filling the energy storage device volume with electrolyte in not greater than 15 minutes.

5. A method comprising:
providing an energy storage device comprising at least one porous element,
introducing electrolyte to the energy storage device, and
applying electrical potential sufficient to increase the rate at which the electrolyte permeates the at least one porous element

6. A method comprising:
providing an energy storage device comprising at least one porous element,
exposing the storage cell to an electric field, and
introducing electrolyte to the energy storage device.

7. A method comprising:
providing an energy storage device comprising at least one porous element,
introducing electrolyte to the energy storage device,
electrophorectically forcing the electrolyte to permeate the porous element.

8. A method comprising:
providing an energy storage device having a volume of not less than 80 cm³ and comprising at least one porous element,
introducing electrolyte to the energy storage device, and
applying electrical potential sufficient to cause the electrolyte to permeate the at least one porous element and fill the volume in not greater than 15 minutes.

9. A method comprising:
providing an energy storage device having a volume of not less than 80 cm³ and comprising at least one porous element, and
electrophoretically permeating the at least one porous element and filling the volume with electrolyte in not greater than 15 minutes.

10. A method comprising:
providing an energy storage device having a volume of not less than 80 cm³ and comprising at least one porous element,
introducing electrolyte to the energy storage device, and
applying electrical potential sufficient to increase the rate at which the electrolyte permeates the at least one porous element and fill the volume with electrolyte in not greater than 15 minutes.

11. A method comprising:
providing an energy storage device having a volume of not less than 80 cm³ and comprising at least one porous element,
exposing the storage cell to an electric field, and
introducing electrolyte to the energy storage device and filling the volume with electrolyte in not greater than 15 minutes.

12. A method comprising:
providing an energy storage device having a volume of not less than 80 cm³ and comprising at least one porous element,
introducing electrolyte to the energy storage device,
electrophorectically forcing the electrolyte to permeate the porous element and fill the volume with electrolyte in not greater than 15 minutes.

13. An energy storage device manufactured in accordance with the method defined by any of claims 1-12.

14. A device comprising:
a track configured to receive an energy storage cell, and
at least one electrode configured to electrify an electrolyte solution within the energy storage cell.

15. The device of claim 14, wherein the at least one electrode is spring loaded.

16. The device of claim 14, comprising an indexing mechanism.

17. The device of claim 16, wherein the track is configured to hold more than one energy storage cell.

18. The device of claim 14, wherein the energy storage cell has a coiled structure.

19. The device of claim 14, wherein the energy storage cell has a prismatic structure.

20. A method, comprising:
exposing an energy storage cell to an electric field, and
adding an electrolyte solution to the energy storage cell.

21. A method for increasing the rate at which an electrolyte solution permeates the micropores of the plates of an energy storage cell, comprising:
providing an energy storage cell having at least one pair of plates,
exposing the energy storage cell to an electric field, and
adding an electrolyte solution.

22. The method of claim 21 wherein the plates are a galvanic couple of dissimilar metals.

23. The method of claim 21 wherein the plates are each coated with an electrolytic paste to form at least one anode and at least one cathode.

24. The method of claim 21 wherein the electrolyte is potassium hydroxide.

25. A method for electrophoretically adding an electrolyte solution to an energy storage cell, comprising:
adding an electrolyte to an energy storage cell, and
exposing the electrolyte to an electric current.

26. A method comprising:
providing an energy storage device comprising at least one porous element,
introducing electrolyte to the energy storage device, and
establishing an electrical current sufficient to cause the electrolyte to permeate the at least one porous element.

27. A method comprising:
providing an energy storage device comprising at least one electrode,
establishing an electrical current relative to the at least one electrode, and
introducing electrolyte to the energy storage device.

28. A method comprising:
providing an energy storage device having a volume not less than 80 cm³ and comprising at least one electrode,
establishing an electrical current relative to the at least one electrode, and
filling the energy storage device volume with electrolyte in not greater than 15 minutes.

29. A method comprising:
providing an energy storage device comprising at least one porous element,
introducing electrolyte to the energy storage device, and
establishing an electrical current sufficient to increase the rate at which the electrolyte permeates the at least one porous element

30. A method comprising:
providing an energy storage device having a volume of not less than 80 cm³ and comprising at least one porous element,
introducing electrolyte to the energy storage device, and
establishing an electrical current sufficient to cause the electrolyte to permeate the at least one porous element and fill the volume in not greater than 15 minutes.

31. A method comprising:
providing an energy storage device having a volume of not less than 80 cm³ and comprising at least one porous element,
introducing electrolyte to the energy storage device, and
establishing an electrical current sufficient to increase the rate at which the electrolyte permeates the at least one porous element and fill the volume with electrolyte in not greater than 15 minutes.

32. A device comprising:
at least one electrode,
means for relatively positioning the at least one electrode and an energy storage cell, the energy storage cell comprising at least one porous element, the at least one electrode being configured to establish electrical potential sufficient to cause an electrolyte to permeate the at least one porous element.

33. A device comprising:
at least one electrode,
means for relatively positioning the at least one electrode and an energy storage cell, the energy storage cell comprising at least one porous element, the at least one electrode being configured to establish electrical current sufficient to cause an electrolyte to permeate the at least one porous element.
